(19) United States
(12) Patent Application Publication
(10) Pub. No.: US 2026/0112772 A1
(43) Pub. Date: Apr. 23, 2026

(54) OXYGEN PLASMA TREATED SEPARATORS FOR LITHIUM METAL BATTERIES HAVING ELECTROLYTE WITH HIGH SALT CONCENTRATION

(71) Applicants: Lin-Shu Du, Lansdale, PA (US); Art Driedger, Spring City, PA (US); Chao Shen, Hatfield, PA (US); Brendan Hayes-Oberst, West Chester, PA (US)

(72) Inventors: Lin-Shu Du, Lansdale, PA (US); Art Driedger, Spring City, PA (US); Chao Shen, Hatfield, PA (US); Brendan Hayes-Oberst, West Chester, PA (US)

(21) Appl. No.: 17/300,255

(22) Filed: Apr. 30, 2021

(51) Int. Cl. H01M 50/403; H01M 4/38; H01M 10/052; H01M 50/417; H01M 50/449

(52) U.S. Cl. CPC H01M 50/403; H01M 4/382; H01M 10/052; H01M 50/417; H01M 50/449

(57) ABSTRACT

Disclosed herein are porous separators having a surface energy of at least 50 dynes/cm, which separators can be prepared by radiating oxygen plasma on a microporous polymer film. The oxygen plasma treatment yields significant reduction in electrolyte contact angle and wetting time of said separators when they are in contact with an electrolyte with high salt concentration. As a result, the oxygen plasma treatment improves the wetting by the electrolyte with high salt concentration and enables its use for high capacity and long cycle life rechargeable lithium metal batteries, which are also described herein.

### BACKGROUND OF THE INVENTION

### Field of the Invention

This invention relates to the use of plasma treated separator to improve the performance of a lithium metal battery with electrolyte having high salt concentration. With the oxygen plasma treatment, the surface modified microporous polymer-based separator has higher surface polarity and shows outstanding wetting towards electrolyte with high salt concentration. Such improvement could be beneficial for reducing the cell internal resistance and increasing the rate capability and cycle life performance of the rechargeable lithium metal battery.

### Description of the Related Art

A rechargeable lithium metal battery is an electrochemical energy storage device which comprises an intercalating metal oxide compound cathode, a lithium metal anode, a porous separator, and a liquid electrolyte as active components, enclosed in a moisture-proof enclosure. Such battery was first developed in the 1970s, but its practical applications have been hindered by the safety concern and low Coulombic efficiency associated with lithium anode. Recently, considerable efforts have been spent on rechargeable lithium metal battery because of its much higher energy density as compared with current graphite-based lithium-ion battery. Among these efforts, liquid electrolyte with high salt concentration has been developed to enable stable lithium deposition and dissolution during discharge and charge cycles. Rechargeable lithium metal battery with such electrolyte is reported to achieve two times higher energy density over lithium-ion battery and having improved cycle life. However, high salt concentration results in high viscosity, which leads to poor wetting of separators, and in turn is negatively influencing cycle life and power density. Therefore, there is a need to develop new separators compatible with electrolyte with high salt concentration.

### SUMMARY OF THE INVENTION

It has now been found that oxygen plasma treatment, in which the surface layer of hydrogen atoms on the polymer separator were replaced with oxygen atoms, can greatly enhance the surface energy of the polymer separator. With the enhanced surface energy, the oxygen plasma treated separator yields significant reduction in wetting time and the electrolyte contact angle when in contact with the electrolyte with the high salt concentration. Additionally, after long-term storage of 161 days, the oxygen plasma treated separator showed little or no change in the wetting capability.

Principal object of the invention is to provide separators which absorb electrolytes with high salt concentration of at least 2 M and facilitate fast wetting.

Another object of the invention is to provide separators for lithium metal batteries, which improve ionic conductivity.

Another object of the invention is to provide separators which resist creation of dendrites.

### BRIEF DESCRIPTION OF THE DRAWINGS

The nature and characteristic features of the invention will be more readily understood from the following description taken in connection with the accompanying drawing, in which:

FIG. 1 is the top view of the wetting test chamber on the drawing (top) and the actual fixture picture (bottom).

FIG. 2 is showing the wetting result of an untreated polyethylene separator with high concentration sulfolane based electrolyte.

FIG. 3 is showing the wetting result of an oxygen plasma treated polyethylene separator with high concentration sulfolane based electrolyte.

FIG. 4 is showing the wetting result of an oxygen plasma treated polyethylene separator before (top), and after (bottom), being stored for 161 days at room temperature.

FIG. 5 is showing comparison of cycle tests of lithium nickel manganese cobalt oxide/lithium metal cells with a high concentration sulfolane based electrolyte using different separators. The separators tested include glass fiber, untreated polyethylene, and oxygen plasma treated polyethylene separators. Due to the poor wetting, the cell with untreated polyethylene separator cannot be cycled and therefore its data is not presented. The charge and discharge rates are C/10-C/10 for the first 3 cycles, then C/5-C/5 for cycles 4 to 6, then C/2-C/2 for cycles 7 to 9, then 1 C-2 C for following cycles.

It should, of course, be understood that various modifications and changes can be made in the compositions and the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function substantially same way to bring about the same results.

Electrolyte plays a vital role in rechargeable lithium metal battery to allow the conduction of ions between cathode and anode. Conventional liquid electrolytes used in rechargeable lithium metal battery typically have a lithium salt concentration of less than 1.5 M. Recently, a new type of electrolyte, i.e., electrolyte with high salt concentration (higher than 2.0 M or 2.0 m), has been developed to enhance the cycling performance of rechargeable lithium metal battery. The higher lithium salt concentration facilitates higher current density and minimizes the lithium dendrites formation, as well as provides more lithium ions supply at the anode during charge. Furthermore, a higher lithium salt concentration in the electrolyte increases the flux of lithium ions between the electrodes and raises the lithium ion mass transfer rate between the electrolyte and anode, thereby enhancing the uniformity of lithium deposition and dissolution during cycling and improving the Coulombic efficiency.

The electrolyte with high salt concentration can include one or multiple non-aqueous organic solvents and one or multiple lithium salts.

The non-aqueous organic solvent with a lithium salt serves as a medium for transmitting ions taking part in the electrochemical reaction of the battery. The non-aqueous organic solvent may include a carbonate-based, ester-based, ether-based, ketone-based, alcohol-based, or aprotic solvent. The carbonate-based solvent may include diethyl carbonate, dimethyl carbonate, ethylene carbonate, propylene carbonate, dipropyl carbonate, methylpropyl carbonate, ethylpropyl carbonate, methylethyl carbonate, butylene carbonate, and the like. The ester-based solvent may include methyl acetate, ethyl acetate, n-propylacetate, methylpropinonate, ethylpropinonate, y-butyrolactone, decanolide, valerolactone, mevalonolactone, caprolactone, and the like. The ether-based solvent includes dibutylether, tetraglyme, diglyme, dimethoxyethane, 2-methyltetrahydrofuran, tetrahydrofuran, or the like, and the ketone based solvent include cyclohexanone, or the like. The alcohol-based solvent includes ethyl alcohol, isopropyl alcohol, and the like, and the aprotic solvent include nitriles such as R-CN (wherein R is a C₂ to C₂₀ linear, branched, or cyclic hydrocarbon group including a double bond, an aromatic ring, or an ether bond), amides such as dimethylformamide, dioxolanes such as 1,3-dioxolane, sulfolane, or the like. The non-aqueous organic solvent may be used singularly or in a mixture.

A lithium salt is dissolved in the organic solvents above and supplies lithium ions in the battery, and provides the basic operation of the rechargeable lithium battery by lithium ions transport between positive and negative electrodes.

Examples of the lithium salt include Li(CF₃SO₂)₂N (LITFSI), Li(FSO₂)₂N (LiFSI), LiPF₆, LiBF₄, LiSbF₆, LiAsF₆, LiN(SO₂C₂F₅)₂, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, LiB(C₂O₄)₂ (LiBOB), or a combination thereof, as a supporting electrolytic salt. The lithium salt may be used in a concentration of higher than 2.0 M or 2.0 m in the solvents.

In general, the separator plays a role of electrically separating positive and negative electrodes and passing lithium ions between the two electrodes. When a separator is better wetted by the electrolyte, a better lithium ion mobility within the separator is achieved. Consequently, low cell internal resistance and high electrolyte filling speed is achieved. As the lithium salt concentration increases, ion pairing begins to form, leading to increased viscosity, decreased ion conductivity, and reduced wetting of the electrodes and separator. When a separator shows poor wetting with the electrolyte, the lithium ion mobility is deteriorated and consequently the battery cannot function well. In addition, the long wetting time of the separator can be a rate limiting step in the battery manufacturing process. Therefore, electrolyte with high lithium salt requires a separator that has different characteristics from those used with conventional electrolytes.

According to one embodiment of the invention, a separator for rechargeable lithium metal battery having a surface energy of at least 50 dynes/cm is provided by oxygen plasma treatment. The oxygen plasma treated separator has a higher surface energy than an untreated separator (about 30 dynes/cm). Said separator has preferably surface angle against distilled water of about 15 to 20 degrees, at 25° C.

With the enhanced surface energy, the separator is expected to wet electrolytes especially those with high salt concentration better. Thus, using the oxygen plasma treated separator improves battery performance such as discharge capacity and cycle life of the rechargeable lithium metal battery employing electrolyte with high salt concentration. Such separators have an oxygen containing functional group bonded to the surface, and different various radiation gases may be used.

Said separators are made from porous polymers, such as polyethylene, polypropylene, polyvinylidene fluoride and combination thereof.

These separators may also have a porous polymeric material coated on their surface. Such separators may be also used in lithium-ion batteries.

Example embodiments will hereinafter be described in detail. However, these embodiments are only examples, and are not limiting the invention.

### EXAMPLE 1

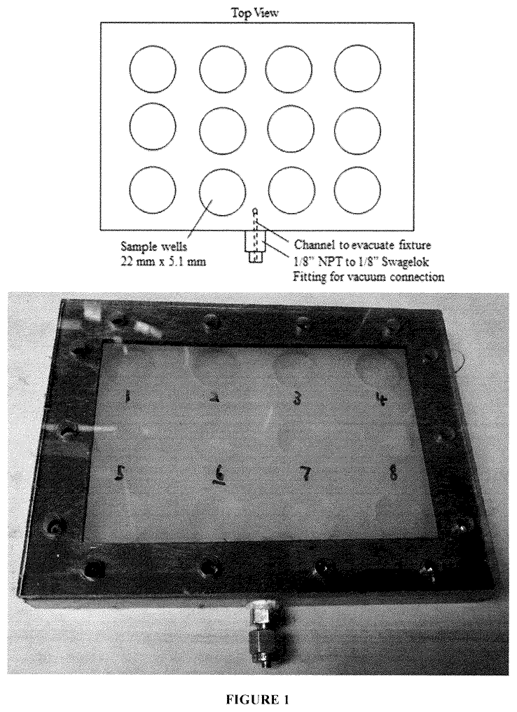

A test chamber has been designed and constructed for visual determination of separator wetting in a closed system as shown in FIG. 1, which is one embodiment of the invention. The diameter of the separator disk is 2 cm and a volume of 50 μL of the tested electrolyte is accurately placed on an untreated polyethylene separator disk using a micropipette. Afterwards, the Plexiglas cover is screwed on to reduce any solvent evaporation. Each of the separator disks was then photographed at various time intervals to measure the progress of the wetting.

### COMPARATIVE EXAMPLE 1

A wetting test was conducted according to the same method as Example 1 except for using an oxygen plasma treated polyethylene separator.

### COMPARATIVE EXAMPLE 2

A wetting test was conducted according to the same method as Example 1 except for using an oxygen plasma treated polyethylene separator being stored in a dry room at room temperature for an additional 161 days.

### EXAMPLE 2

A LiNi_{0.6}Mn_{0.2}Co_{0.2}O₂ (NMC-622) positive electrode was fabricated by mixing an NMC-622 positive active material, conductive materials (carbon black and conducting graphite), and a polyvinylidene fluoride binder in an N-methyl pyrrolidone (NMP) solvent in a weight ratio of 90:6:4 to prepare a positive active material composition and then coating the positive active material composition on an aluminum current collector. The NMP was then dried out.

A negative electrode is a pre-cut pure lithium chip with a thickness of 0.6 mm.

A sulfolane based electrolyte with high salt concentration was prepared by mixing solvent in a desired molar ratio and dissolving 2 M of lithium salt therein.

A rechargeable lithium metal battery cell was fabricated by assembling the NMC positive electrode with an untreated polyethylene separator and the lithium metal negative electrode in this sequence into a CR2032-type coin cell. 200 μL of electrolyte with high salt concentration was injected into the coin cell.

### COMPARATIVE EXAMPLE 3

A rechargeable lithium metal battery cell was fabricated according to the same method as Example 2 except the untreated polyethylene separator was replaced by the oxygen plasma treated polyethylene separator.

### COMPARATIVE EXAMPLE 4

A rechargeable lithium metal battery cell was fabricated according to the same method as Example 2 except the untreated polyethylene separator was replaced by a glass fiber separator.

### Wetting Time Measurement

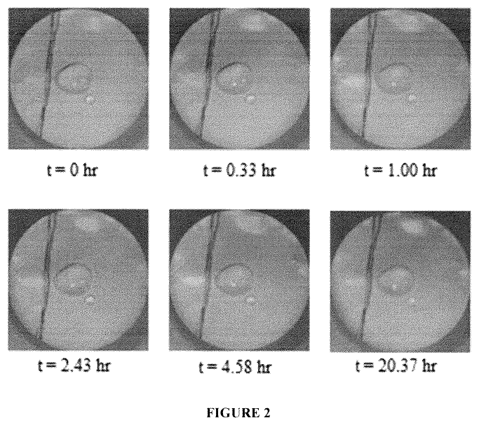

A wetting time measurement was conducted according to Example 1, Comparative Example 1 and 2. As shown in FIG. 2, which is another embodiment of the invention, the untreated polyethylene separator shows little wetting capability towards the electrolyte with high salt concentration. Even after 20 hours, the separator is not wetted at all.

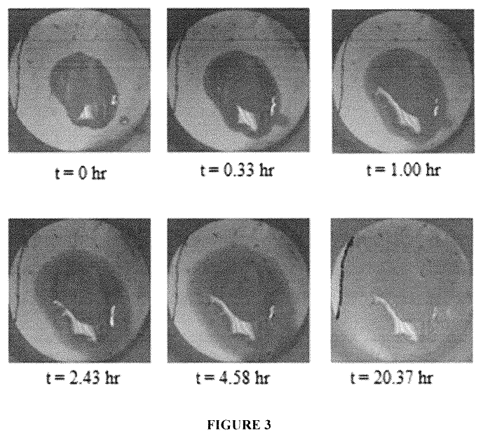

As shown in FIG. 3, which is another embodiment of the invention, there is a dramatic increase in wetting capability on both sides of the treated separator. The initial contact angle is much lower than that with an untreated separator. A significant portion of the separator has been wetted within 1 hour and the separator is fully wet within 20 hours.

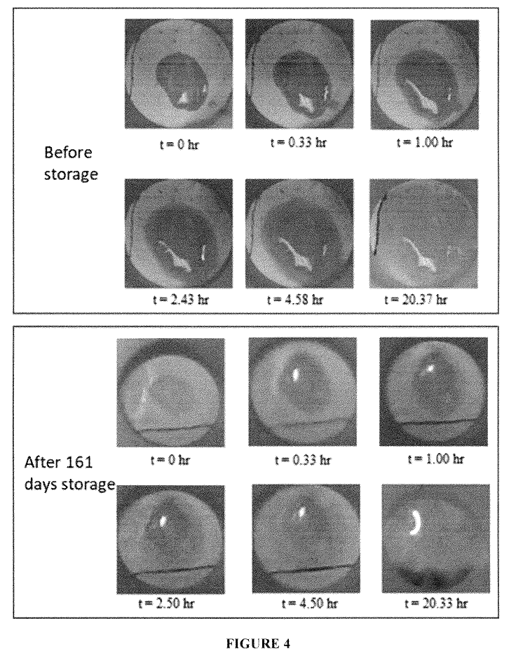

The wetting test was repeated later to ensure the treatment is not degraded over time. As seen in FIG. 4, which is another embodiment of the invention, after 161 days of storage in a dry room at room temperature, the oxygen plasma treated separator shows little or no change of the wetting capability toward electrolyte with high salt concentration and is still able to be fully wetted within 20 hours of electrolyte injection.

### Cycle Life Performance

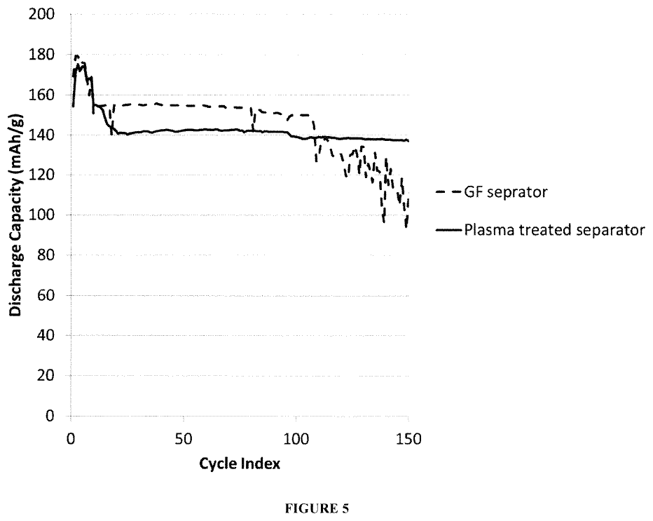

The rechargeable lithium metal battery cells according to Example 2 and Comparative Example 3 and 4 were cycled with a charge rate of 1 C and a discharge rate of 2 C and measured regarding discharge capacity. Before starting the cycles at 1 C-2 C, the charge and discharge rates are C/10-C/10 for the first 3 cycles, then C/5-C/5 for cycles 4 to 6, then C/2-C/2 for cycles 7 to 9. The cycle life characteristics are plotted in FIG. 5, which is another embodiment of the invention. The cell with untreated polyethylene separator cannot be cycled due to the poor electrolyte wetting condition. The cell with the oxygen plasma treated separator shows slightly lower but stable discharge capacity and better cycle retention as compared to untreated glass fiber separator, which developed dendrites and caused shorting.

It will thus be seen, that highly ion conductive separators for lithium metal batteries, wetted by electrolytes with high salt concentration have been provided, with which the objects of the invention are achieved.

We claim:

1. A rechargeable lithium metal battery compromising:
a positive electrode made of a lithium intercalating compound active material;
a negative electrode made of a lithium metal;
a separator having a surface energy of at least 50 dynes/cm, and
an electrolyte with high salt concentration greater or equal than 2.0 M.

2. A rechargeable lithium metal battery as described in claim 1, in which said separator is treated by oxygen plasma.

3. A rechargeable lithium metal battery as described in claim 1, in which said separator has an oxygen-containing functional group bonded to the surface thereof.

4. A rechargeable lithium metal battery as described in claim 1, in which said separator has varied oxygen-containing functional group by using different radiation gases during plasma treatment.

5. A rechargeable lithium metal battery as described in claim 2, in which said separator is a porous polymer film selected from the group which includes polyethylene, polypropylene, polyvinylidene fluoride, and a combination thereof.

6. A rechargeable lithium metal battery as described in claim 1, in which said separator has a polymeric material surface coating.

7. A rechargeable lithium metal battery as described in claim 1, in which said separator has a surface contact angle against distilled water of from 15° to 20° at 25° C.

8. A rechargeable lithium metal battery as described in claim1, in which said electrolyte solvent is a is non-aqueous organic solvent selected from group which includes carbonate-based, ester-based, ether-based, ketone-based, alcohol-based, or aprotic solvent, and a combination thereof.

9. A rechargeable lithium metal battery as described in claim 1, in which said electrolyte salt is a is a lithium salt selected from group which includes Li(CF₃SO₂)₂N (LITFSI), Li(FSO₂)₂N (LiFSI), LiPF₆, LiBF₄, LiSbF₆, LiAsF₆, LiN(SO₂C₂F₅)₂, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, LiB(C₂O₄)₂ (LiBOB), and a combination thereof.

10. A separator for lithium based batteries, which is made from a porous polymer film treated by oxygen plasma, and said separator has a surface energy at least 50 dynes/cm.
